(19) United States
(12) Patent Application Publication
(10) Pub. No.: US 2015/0189322 A1
(43) Pub. Date: Jul. 2, 2015

(54) Sub-bitstream Extraction Process for HEVC Extensions

(71) Applicant: VID SCALE, INC., Wilmington, DE (US)

(72) Inventors: Yong He, San Diego, CA (US); Yan Ye, San Diego, CA (US)

(21) Appl. No.: 14/579,648

(22) Filed: Dec. 22, 2014

Related U.S. Application Data
(60) Provisional application No. 61/923,190, filed on Jan. 2, 2014.

(51) Int. Cl. H04N 19/597; H04N 19/70; H04N 19/52

(52) U.S. Cl. CPC H04N 19/597; H04N 19/52; H04N 19/70

(57) ABSTRACT

Systems and methods are described for simplifying the sub-bitstream extraction and the rewriting process. In an exemplary method, a video is encoded as a multi-layer scalable bitstream including at least a base layer and a first non-base layer. The bitstream is subject to the constraint that the image slice segments in the first non-base layer each refer to a picture parameter set in the base layer. Additional constraints and extra high level syntax elements are also described. Embodiments are directed to (i) constraints on the output layer set for sub-bitstream extraction process; (ii) VPS generation for the sub-bitstream extraction process; and (iii) SPS/PPS generation for the sub-bitstream extraction process.

### CROSS-REFERENCE TO RELATED APPLICATIONS

The present application is a non-provisional filing of, and claims benefit under 35 U.S.C. §119(e) from, U.S. Provisional Patent Application Ser. No. 61/923,190, filed Jan. 2, 2014, incorporated herein by reference in its entirety.

### BACKGROUND

Over the past two decades, various digital video compression technologies have been developed and standardized to enable efficient digital video communication, distribution and consumption. Most of the commercially widely deployed standards are developed by ISO/IEC and ITU-T, such as H.261, MPEG-1, MPEG-2 H.263, MPEG-4 (part-2), and H.264/AVC (MPEG-4 part 10 Advance Video Coding). Due to the emergence and maturity of new advanced video compression technologies, a new video coding standard, High Efficiency Video Coding (HEVC), under joint development by ITU-T Video Coding Experts Group (VCEG) and ISO/IEC MPEG. HEVC (ITU-T H.265/ISO/IEC 23008-2) was approved as an international standard in early 2013, and is able to achieve substantially higher coding efficiency than the current state-of-the-art H.264/AVC.

Compared to traditional digital video services (such as sending TV signals over satellite, cable and terrestrial transmission channels), more and more new video applications, such as IPTV, video chat, mobile video, and streaming video, are deployed in heterogeneous environments. Such heterogeneity exists on the clients as well as in the network. On the client side, the N-screen scenario, that is, consuming video content on devices with varying screen sizes and display capabilities, including smart phone, tablet, PC and TV, already does and is expected to continue to dominate the market. On the network side, video is being transmitted across the Internet, Wi-Fi networks, mobile (3G and 4G) networks, and/or any combination of them. To improve the user experience and video quality of service, scalable video coding is an attractive solution. Scalable video coding is to encode the signal once at the highest resolution, but enable decoding from subsets of the streams depending on the specific rate and resolution required by certain application and/or supported by the client device. Note that, as used here, the term “resolution” is defined by a number of video parameters, including but is not limited to, spatial resolution (picture size), temporal resolution (frame rate), and video quality (subjective quality such as MOS, and/or objective quality such as PSNR or SSIM or VQM). Other commonly used video parameters include chroma format (such as YUV420 or YUV422 or YUV444), bit-depth (such as 8-bit or 10-bit video), complexity, view, gamut, and aspect ratio (16:9 or 4:3). The existing international video standards such as MPEG-2 Video, H.263, MPEG4 Visual and H.264 all have tools and/or profiles that support scalability modes. As the HEVC standard version 1 was standardized in January 2013, the work to extend HEVC to support scalable coding is already underway. The first phase of HEVC scalable extension is expected to support at least spatial scalability (i.e., the scalable bitstream contains signals at more than one spatial resolution), quality scalability (i.e., the scalable bitstream contains signals at more than one quality level), and standard scalability (i.e., the scalable bitstream contains a base layer coded using H.264/AVC and one or more enhancement layers coded using HEVC). Quality scalability is also often referred to as SNR scalability. Additionally, as 3D video becomes more popular nowadays, separate work on view scalability (i.e., the scalable bitstream contains both 2D and 3D video signals) is underway in JCT-3V.

The common specification text for the scalable and multi-view extensions of HEVC was proposed jointly by Nokia, Qualcomm, InterDigital and Vidyo in the 12th JCTVC meeting. In the 13^{th} JCTVC meeting, the reference index base framework was adopted as the only solution for the scalable extensions of HEVC (SHVC). A further SHVC working draft specifying the syntax, semantics and decoding processes for SHVC is SHVC draft 4, which was completed after 15^{th} JCTVC meeting in November 2013.

### SUMMARY

Described herein are systems and methods related to the sub-bitstream extraction and the re-writing process. Some constraints and extra high level syntax elements are proposed herein in order to simplify the extraction and re-writing process. Embodiments are directed to (i) constraints on the output layer set for sub-bitstream extraction process; (ii) VPS generation for the sub-bitstream extraction process; and (iii) SPS/PPS generation for the sub-bitstream extraction process.

In some embodiments, a method is described for encoding a video as a multi-layer scalable bitstream. The bitstream includes at least a base layer and a first non-base layer. Each of the layers includes a plurality of image slice segments, and at least the base layer includes at least one picture parameter set (PPS). The base layer and the first non-base layer each include a plurality of image slice segments. Each of the image slice segments in the first non-base layer refers to a respective one of the picture parameter sets in the base layer. More specifically, in some embodiments, each of the image slice segments in the first non-base layer may refer to a picture parameter set having a layer identifier nuh_layer_id of zero.

The base layer may include a plurality of network abstraction layer (NAL) units having a layer identifier nuh_layer_id of zero, and the first non-base layer may include a plurality of network abstraction layer (NAL) units having a layer identifier nuh_layer_id greater than zero. The non-base layer may be an independent layer. The bitstream may further include additional layers, such as a second non-base layer.

Each layer may be associated with a layer identifier. The multi-layer scalable bitstream may include a plurality of network abstraction layer (NAL) units, each NAL unit including a layer identifier.

The base layer may include at least one sequence parameter set (SPS), with each of the image slice segments in the first non-base layer referring to a respective one of the sequence parameter sets in the base layer. The image slice segments in the first non-base layer may each refer to a sequence parameter set having a layer identifier nuh_layer_id of zero.

In some embodiments, the multi-layer scalable bitstream is rewritten as a single-layer bitstream. In such embodiments, when the multi-layer scalable bitstream includes a sps_max_sub_layers_minus1 parameter, the sps_max_sub_layers_minus1 parameter is preferably not changed during the rewriting process. When the multi-layer scalable bitstream includes a profile_tier_level( ) parameter, the profile_tier_level( ) parameter is preferably not changed during the rewriting process.

In some embodiments, the multi-layer scalable bitstream includes at least one sequence parameter set (SPS) with a first plurality of video parameters, and the multi-layer scalable bitstream further includes at least one video parameter set (VPS) with a second plurality of video parameters. Each of the image slice segments in the first non-base layer refers to a respective one of the sequence parameter sets in the base layer and to a respective one of the video parameter sets, and a first subset of the first plurality of video parameters and a second subset of the second plurality of video parameters are equal. The respective subsets of the first plurality of video parameters and the second plurality of video parameters may include the parameters of a rep_format( ) syntax structure. In some embodiments, the first plurality of video parameters and the second plurality of video parameters include the parameters:

chroma_format_vps_idc,

separate_colour_plane_vps_flag,

pic_width_vps_in_luma_samples,

pic_height_vps_in_luma_samples,

bit_depth_vps_luma_minus8, and

bit_depth_vps_chroma_minus8.

In some embodiments, the multi-layer scalable bitstream is rewritten as a single-layer bitstream, and the rewriting is performed without altering the sequence parameter sets and video parameter sets referred to by the image slice segments in the first non-base layer.

The present disclosure further describes methods that may be performed, for example, by a middle box such as a bitstream extractor. In some exemplary methods, a video encoded as a multi-layer scalable bitstream is received. The video includes at least a base layer and a first non-base layer. Each of the layers includes a plurality of image slice segments, and the base layer includes at least one picture parameter set (PPS). The base layer and the first non-base layer each include a plurality of image slice segments, and each of the image slice segments in the first non-base layer refers to a respective one of the picture parameter sets in the base layer. The video is then rewritten as a single-layer bitstream. The single-layer bitstream may be sent over a network interface. At least one of the picture parameter sets may include a set of syntax elements. These syntax elements may be preserved in the rewriting process.

In some embodiments, the base layer includes at least one sequence parameter set (SPS), and each of the image slice segments in the first non-base layer refers to a respective one of the sequence parameter sets in the base layer. In such embodiments, where the sequence parameter set includes a set of syntax elements, the rewriting process can include preserving the set of syntax elements. The set of preserved syntax elements can include, for example, the elements:

sps_max_sub_layers_minus1,

sps_temporal_id_nesting_flag, and

profile_tier_level( ).

The methods described herein may be performed by a video encoder and/or a network entity, provided with a processor and a non-transitory storage medium, and programmed to perform the methods disclosed herein.

### BRIEF DESCRIPTION OF THE DRAWINGS

A more detailed understanding may be had from the following description, presented by way of example in conjunction with the accompanying drawings.

FIG. 1 is a block diagram illustrating an example of a block-based video encoder.

FIG. 2 is a block diagram illustrating an example of a block-based video decoder.

FIG. 3 is a diagram of example architecture of a two-layer scalable video encoder.

FIG. 4 is a diagram of example architecture of a two-layer scalable video decoder.

FIG. 5 is a diagram illustrating an example of a two view video coding structure.

FIG. 6 is a diagram illustrating an example inter-layer prediction structure.

FIG. 7 is a diagram illustrating an example of a coded bitstream structure.

FIG. 8 depicts an example of single layer sub-bitstream extraction.

FIG. 9 depicts an example of multiple layer sub-bitstream extraction.

FIG. 10 depicts an example of re-writing process.

FIG. 11 depicts an example of layer sets of the bitstream (BitstreamA) for multiple hop sub-bitstream extraction.

FIG. 12 depicts an example of the layer set constraint to signal independent non-base layer.

FIG. 13 is a diagram illustrating an exemplary communication system including a bitstream extractor.

FIG. 14 is a diagram illustrating an exemplary network entity.

FIG. 15 is a diagram illustrating an exemplary wireless transmit/receive unit (WTRU).

### DETAILED DESCRIPTION

A detailed description of illustrative embodiments will now be provided with reference to the various Figures. Although this description provides detailed examples of possible implementations, it should be noted that the provided details are intended to be by way of example and in no way limit the scope of the application.

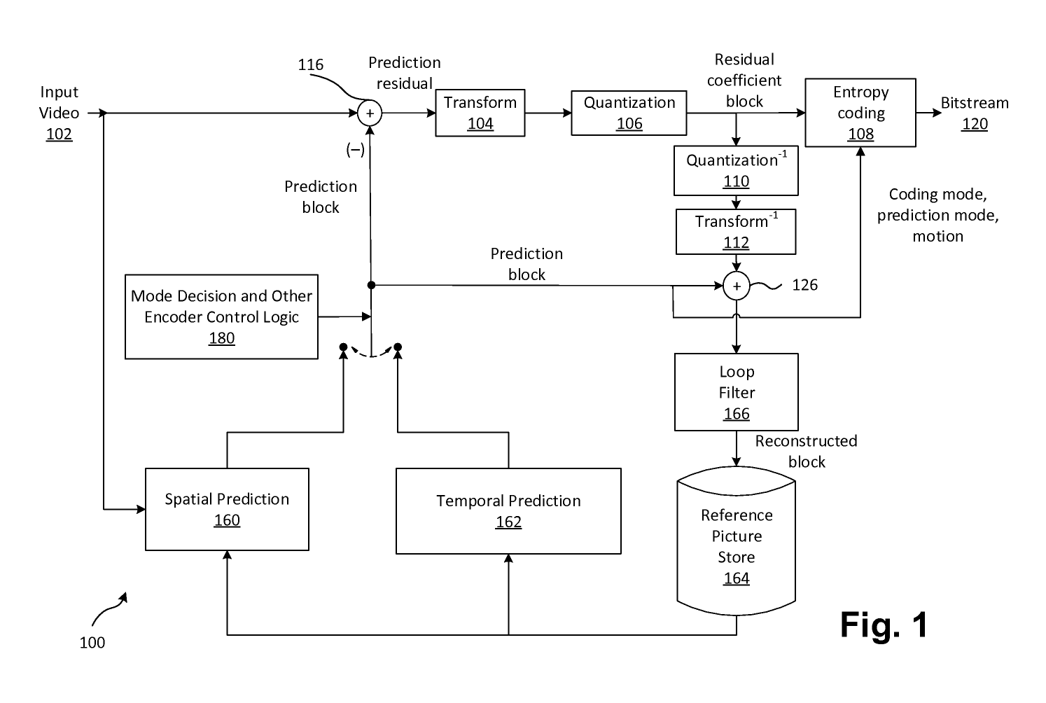

FIG. 1 is a block diagram illustrating an example of a block-based video encoder, for example, a hybrid video encoding system. The video encoder 100 may receive an input video signal 102. The input video signal 102 may be processed block by block. A video block may be of any size. For example, the video block unit may include 16×16 pixels. A video block unit of 16×16 pixels may be referred to as a macroblock (MB). In High Efficiency Video Coding (HEVC), extended block sizes (e.g., which may be referred to as a coding tree unit (CTU) or a coding unit (CU), two terms which are equivalent for purposes of this disclosure) may be used to efficiently compress high-resolution (e.g., 1080p and beyond) video signals. In HEVC, a CU may be up to 64×64 pixels. A CU may be partitioned into prediction units (PUs), for which separate prediction methods may be applied.

For an input video block (e.g., an MB or a CU), spatial prediction 160 and/or temporal prediction 162 may be performed. Spatial prediction (e.g., “intra prediction”) may use pixels from already coded neighboring blocks in the same video picture/slice to predict the current video block. Spatial prediction may reduce spatial redundancy inherent in the video signal. Temporal prediction (e.g., “inter prediction” or “motion compensated prediction”) may use pixels from already coded video pictures (e.g., which may be referred to as “reference pictures”) to predict the current video block. Temporal prediction may reduce temporal redundancy inherent in the video signal. A temporal prediction signal for a video block may be signaled by one or more motion vectors, which may indicate the amount and/or the direction of motion between the current block and its prediction block in the reference picture. If multiple reference pictures are supported (e.g., as may be the case for H.264/AVC and/or HEVC), then for a video block, its reference picture index may be sent. The reference picture index may be used to identify from which reference picture in a reference picture store 164 the temporal prediction signal comes.

The mode decision block 180 in the encoder may select a prediction mode, for example, after spatial and/or temporal prediction. The prediction block may be subtracted from the current video block at 116. The prediction residual may be transformed 104 and/or quantized 106. The quantized residual coefficients may be inverse quantized 110 and/or inverse transformed 112 to form the reconstructed residual, which may be added back to the prediction block 126 to form the reconstructed video block.

In-loop filtering (e.g., a deblocking filter, a sample adaptive offset, an adaptive loop filter, and/or the like) may be applied 166 to the reconstructed video block before it is put in the reference picture store 164 and/or used to code future video blocks. The video encoder 100 may output an output video stream 120. To form the output video bitstream 120, a coding mode (e.g., inter prediction mode or intra prediction mode), prediction mode information, motion information, and/or quantized residual coefficients may be sent to the entropy coding unit 108 to be compressed and/or packed to form the bitstream. The reference picture store 164 may be referred to as a decoded picture buffer (DPB).

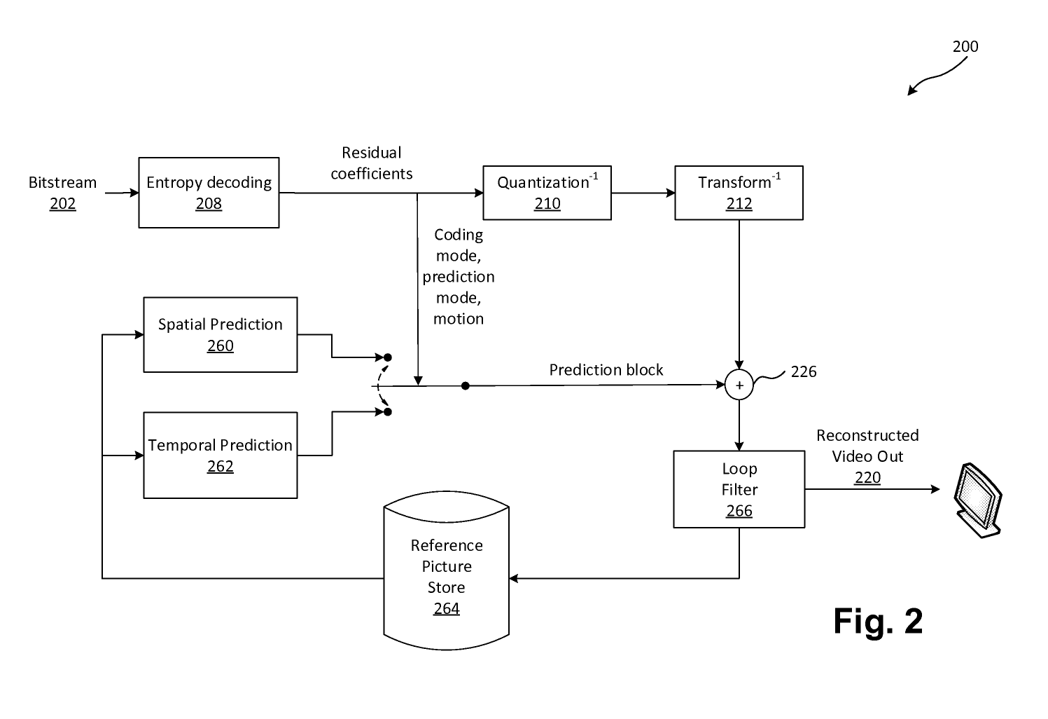

FIG. 2 is a block diagram illustrating an example of a block-based video decoder. The video decoder 200 may receive a video bitstream 202. The video bitstream 202 may be unpacked and/or entropy decoded at entropy decoding unit 208. The coding mode and/or prediction information used to encode the video bitstream may be sent to the spatial prediction unit 260 (e.g., if intra coded) and/or the temporal prediction unit 262 (e.g., if inter coded) to form a prediction block. If inter coded, the prediction information may comprise prediction block sizes, one or more motion vectors (e.g., which may indicate direction and amount of motion), and/or one or more reference indices (e.g., which may indicate from which reference picture to obtain the prediction signal). Motion-compensated prediction may be applied by temporal prediction unit 262 to form a temporal prediction block.

The residual transform coefficients may be sent to an inverse quantization unit 210 and an inverse transform unit 212 to reconstruct the residual block. The prediction block and the residual block may be added together at 226. The reconstructed block may go through in-loop filtering 266 before it is stored in reference picture store 264. The reconstructed video in the reference picture store 264 may be used to drive a display device and/or used to predict future video blocks. The video decoder 200 may output a reconstructed video signal 220. The reference picture store 264 may also be referred to as a decoded picture buffer (DPB).

A single layer video encoder may take a single video sequence input and generate a single compressed bit stream transmitted to the single layer decoder. A video codec may be designed for digital video services (e.g., such as but not limited to sending TV signals over satellite, cable and terrestrial transmission channels). With video centric applications deployed in heterogeneous environments, multi-layer video coding technologies may be developed as an extension of the video coding standards to enable various applications. For example, multiple layer video coding technologies, such as scalable video coding and/or multi-view video coding, may be designed to handle more than one video layer where each layer may be decoded to reconstruct a video signal of a particular spatial resolution, temporal resolution, fidelity, and/or view. Although a single layer encoder and decoder are described with reference to FIG. 1 and FIG. 2, the concepts described herein may utilize a multiple layer encoder and/or decoder, for example, for multi-view and/or scalable coding technologies.

Scalable video coding may improve the quality of experience for video applications running on devices with different capabilities over heterogeneous networks. Scalable video coding may encode the signal once at a highest representation (e.g., temporal resolution, spatial resolution, quality, etc.), but enable decoding from subsets of the video streams depending on the specific rate and representation required by certain applications running on a client device. Scalable video coding may save bandwidth and/or storage compared to non-scalable solutions. The international video standards, e.g., MPEG-2 Video, H.263, MPEG4 Visual, H.264, etc., may have tools and/or profiles that support modes of scalability.

Table 1 provides an example of different types of scalabilities along with the corresponding standards that may support them. Bit-depth scalability and/or chroma format scalability may be tied to video formats (e.g., higher than 8-bit video, and chroma sampling formats higher than YUV4:2:0), for example, which may primarily be used by professional video applications. Aspect ratio scalability may be provided.

TABLE 1

| Scalability | Example | Standards |
|---|---|---|
| View scalability | 2D→3D | MVC, MFC, 3DV |
| | (2 or more views) | |
| Spatial scalability | 720 p→1080 p | SVC, |
| | | scalable HEVC |
| Quality (SNR) scalability | 35 dB→38 dB | SVC, |
| | | scalable HEVC |
| Temporal scalability | 30 fps→60 fps | H.264/AVC, SVC, |
| | | scalable HEVC |
| Standards scalability | H.264/AVC→HEVC | 3DV, |
| | | scalable HEVC |
| Bit-depth scalability | 8-bit video → 10-bit | Scalable HEVC |
| | video | |
| Chroma format | YUV4:2:0→YUV4:2:2, | Scalable HEVC |
| scalability | YUV4:4:4 | |
| Color Gamut Scalability | BT.709 → BT.2020 | Scalable HEVC |
| Aspect ratio scalability | 4:3→16:9 | Scalable HEVC |

Scalable video coding may provide a first level of video quality associated with a first set of video parameters using the base layer bitstream. Scalable video coding may provide one or more levels of higher quality associated with one or more sets of enhanced parameters using one or more enhancement layer bitstreams. The set of video parameters may include one or more of spatial resolution, frame rate, reconstructed video quality (e.g., in the form of SNR, PSNR, VQM, visual quality, etc.), 3D capability (e.g., with two or more views), luma and chroma bit depth, chroma format, and underlying single-layer coding standard. Different use cases may use different types of scalability, for example, as illustrated in Table 1. A scalable coding architecture may offer a common structure that may be configured to support one or more scalabilities (e.g., the scalabilities listed in Table 1). A scalable coding architecture may be flexible to support different scalabilities with minimum configuration efforts. A scalable coding architecture may include at least one preferred operating mode that may not require changes to block level operations, such that the coding logics (e.g., encoding and/or decoding logics) may be maximally reused within the scalable coding system. For example, a scalable coding architecture based on a picture level inter-layer processing and management unit may be provided, wherein the inter-layer prediction may be performed at the picture level.

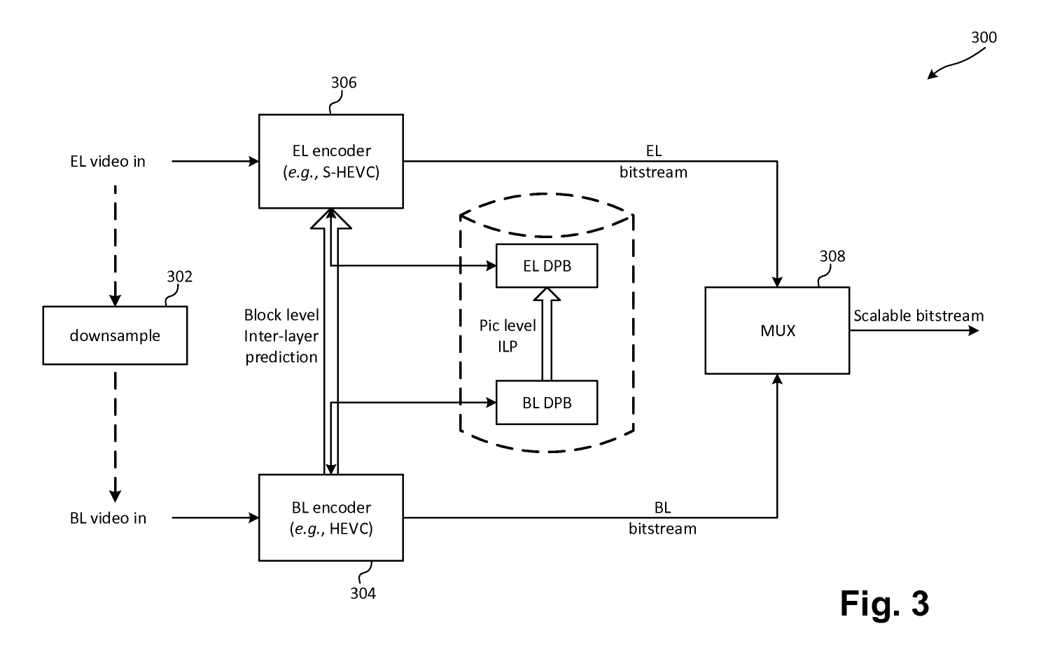

FIG. 3 is a diagram of example architecture of a two-layer scalable video encoder. The video encoder 300 may receive video (e.g., an enhancement layer video input). An enhancement layer video may be down-sampled using a down sampler 302 to create lower level video inputs (e.g., the base layer video input). The enhancement layer video input and the base layer video input may correspond to each other via the down-sampling process and may achieve spatial scalability. The base layer encoder 304 (e.g., an HEVC encoder in this example) may encode the base layer video input block by block and generate a base layer bitstream. FIG. 1 is a diagram of an example block-based single layer video encoder that may be used as the base layer encoder in FIG. 3.

At the enhancement layer, the enhancement layer (EL) encoder 306 may receive the EL input video input, which may be of higher spatial resolution (e.g., and/or higher values of other video parameters) than the base layer video input. The EL encoder 306 may produce an EL bitstream in a substantially similar manner as the base layer video encoder 304, for example, using spatial and/or temporal predictions to achieve compression. Inter-layer prediction (ILP) may be available at the EL encoder 306 to improve its coding performance. Unlike spatial and temporal predictions that may derive the prediction signal based on coded video signals in the current enhancement layer, inter-layer prediction may derive the prediction signal based on coded video signals from the base layer (e.g., and/or other lower layers when there are more than two layers in the scalable system). At least two forms of inter-layer prediction, picture-level ILP and block-level ILP, may be used in the scalable system. Picture-level ILP and block-level ILP are discussed herein. A bitstream multiplexer 308 may combine the base layer and enhancement layer bitstreams together to produce a scalable bitstream.

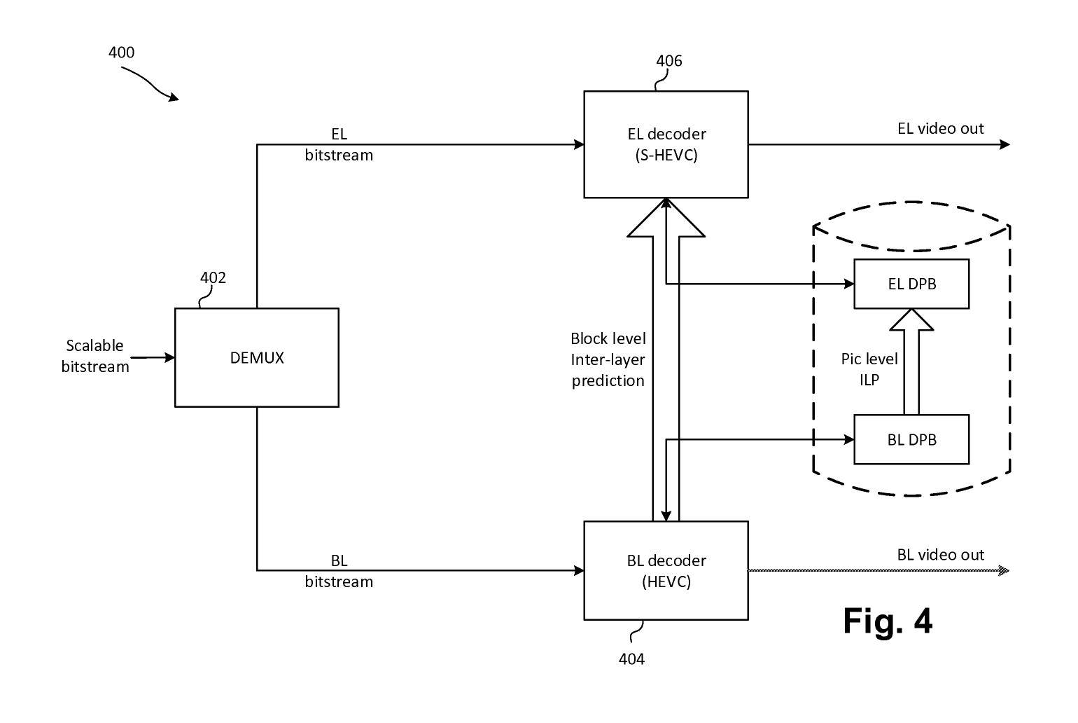

FIG. 4 is a diagram of example architecture of a two-layer scalable video decoder. The two-layer scalable video decoder architecture of FIG. 4 may correspond to the scalable encoder in FIG. 3. The video decoder 400 may receive a scalable bitstream, for example, from a scalable encoder (e.g., the scalable encoder 300). The de-multiplexer 402 may separate the scalable bitstream into a base layer bitstream and an enhancement layer bitstream. The base layer decoder 404 may decode the base layer bitstream and may reconstruct the base layer video. FIG. 2 is a diagram of an example block-based single layer video decoder that may be used as the base layer decoder in FIG. 4.

The enhancement layer decoder 406 may decode the enhancement layer bitstream. The EL decoder 406 may decode the EL bitstream in a substantially similar manner as the base layer video decoder 404. The enhancement layer decoder may do so using information from the current layer and/or information from one or more independent layers (e.g., the base layer). For example, such information from one or more independent layers may go through inter layer processing, which may be accomplished when picture-level ILP and/or block-level ILP are used. Although not shown, additional ILP information may be multiplexed together with base and enhancement layer bitstreams at the MUX 908. The ILP information may be de-multiplexed by the DEMUX 1002.

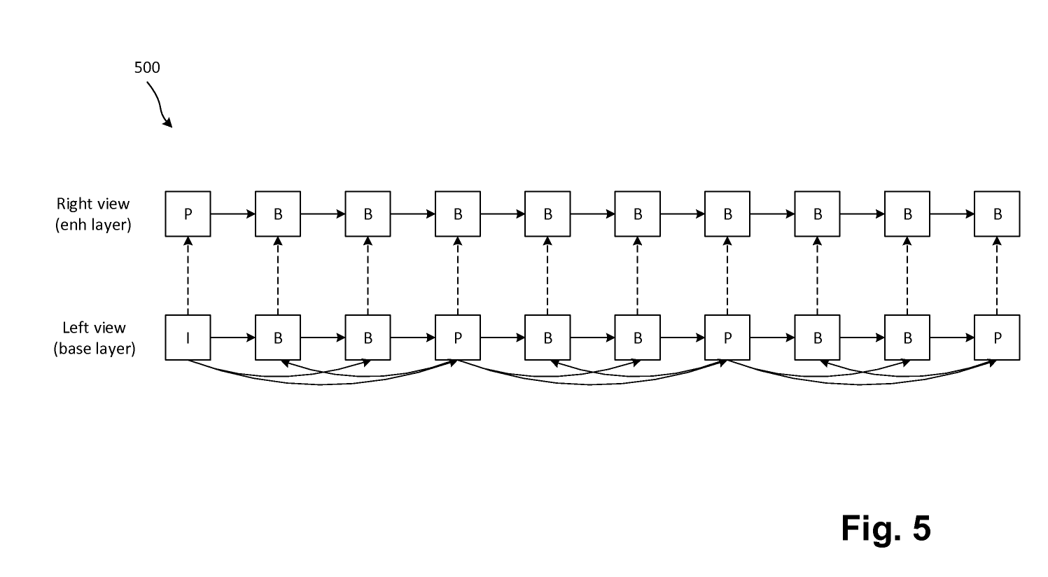

FIG. 5 is a diagram illustrating an example of a two view video coding structure. As shown generally at 500, FIG. 5 illustrates an example of temporal and inter-dimension/layer prediction for two-view video coding. Besides general temporal prediction, the inter-layer prediction (e.g., exemplified by dashed lines) may be used to improve the compression efficiency by exploring the correlation among multiple video layers. In this example, the inter-layer prediction may be performed between two views.

Inter-layer prediction may be employed in an HEVC scalable coding extension, for example, to explore the strong correlation among multiple layers and/or to improve scalable coding efficiency.

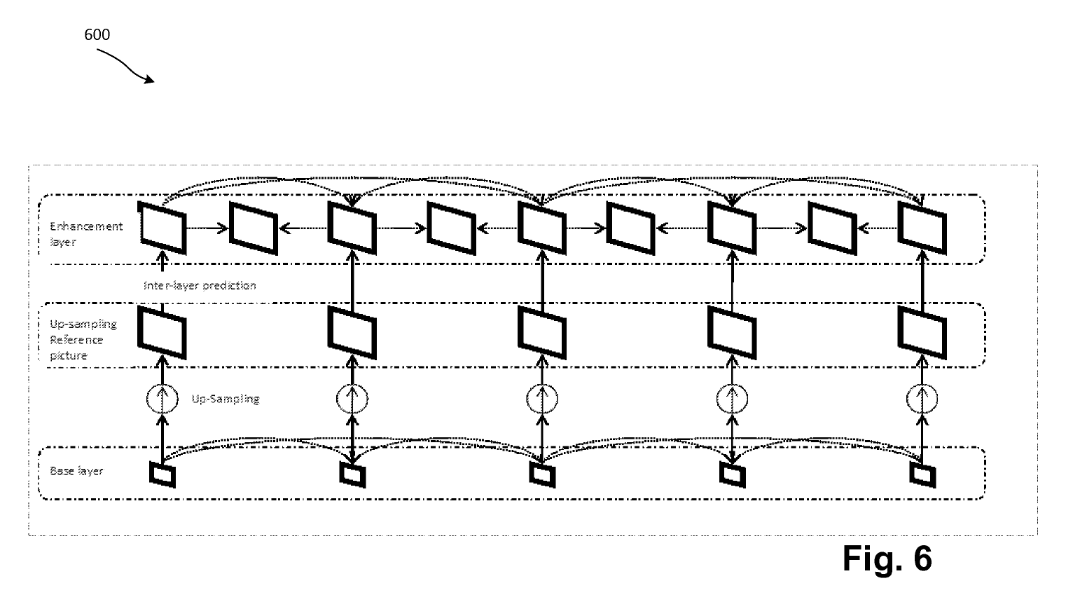

FIG. 6 is a diagram illustrating an example inter-layer prediction structure, for example, which may be considered for an HEVC scalable coding system. As shown generally at 600, the prediction of an enhancement layer may be formed by motion-compensated prediction from the reconstructed base layer signal (e.g., after up-sampling if the spatial resolutions between the two layers are different), by temporal prediction within the current enhancement layer, and/or by averaging a base layer reconstruction signal with a temporal prediction signal. Full reconstruction of the lower layer pictures may be performed. Similar concepts may be utilized for HEVC scalable coding with more than two layers.

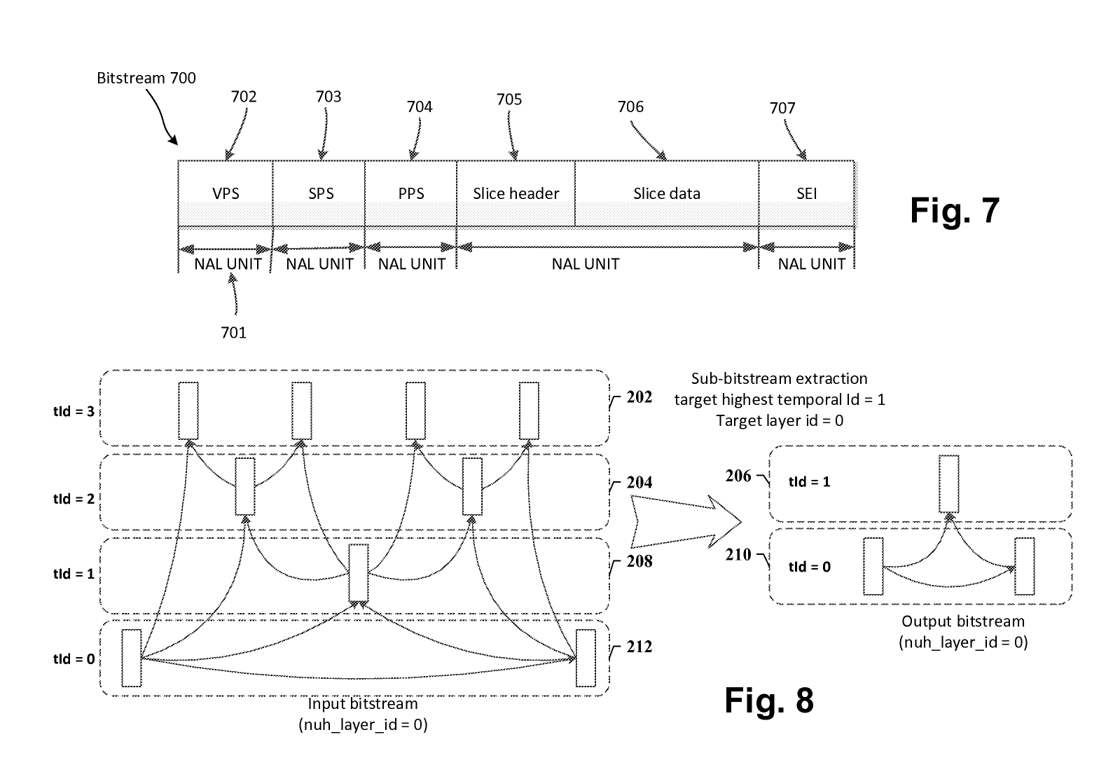

FIG. 7 is a diagram illustrating an example of a coded bitstream structure. A coded bitstream 700 consists of a number of NAL (Network Abstraction layer) units 701. A NAL unit may contain coded sample data such as coded slice 706, or high level syntax metadata such as parameter set data, slice header data 705 or supplemental enhancement information data 707 (which may be referred to as an SEI message). Parameter sets are high level syntax structures containing essential syntax elements that may apply to multiple bitstream layers (e.g. video parameter set 702 (VPS)), or may apply to a coded video sequence within one layer (e.g. sequence parameter set 703 (SPS)), or may apply to a number of coded pictures within one coded video sequence (e.g. picture parameter set 704 (PPS)). The parameter sets can be either sent together with the coded pictures of the video bit stream, or sent through other means (including out-of-band transmission using reliable channels, hard coding, etc.). Slice header 705 is also a high level syntax structure that may contain some picture-related information that is relatively small or relevant only for certain slice or picture types. SEI messages 707 carry the information that may not be needed by the decoding process but can be used for various other purposes, such as picture output timing or display as well as loss detection and concealment.

Aspects of the systems and methods particular to the video coding signal processing and protocol signaling will now be described.

The sub-bitstream extraction process was specified in HEVC standard to facilitate temporal scalability within a single layer video bitstream. The standard specifies the process to extract a sub-bitstream from an input HEVC compliant bitstream with target highest TemporalId value, and a target layer identifier list. During the extraction process, all NAL units with a temporal id greater than the target highest temporal id or the layer identifier not included in the target identifier list are removed, and some SEI NAL units are also removed under certain circumstances as specified in the standard. The output extracted bitstream contains the coded slice segment NAL units with nuh_layer_id equal to 0 and TemporalId equal to 0.

The same sub-bitstream extraction process is applied to the extensions of HEVC, such as multiview extension (MV-HEVC) and scalability extension (SHVC). FIG. 8 depicts an example of single layer sub-bitstream extraction. The input single layer has four temporal sub-layers, tId0 (212), tId1 (208), tId2 (204) and tId3 (202). The target highest temporal id is 1 and the output sub-bitstream contains only temporal sub-layer tId0 (210) and tId1 (206) after extraction process.

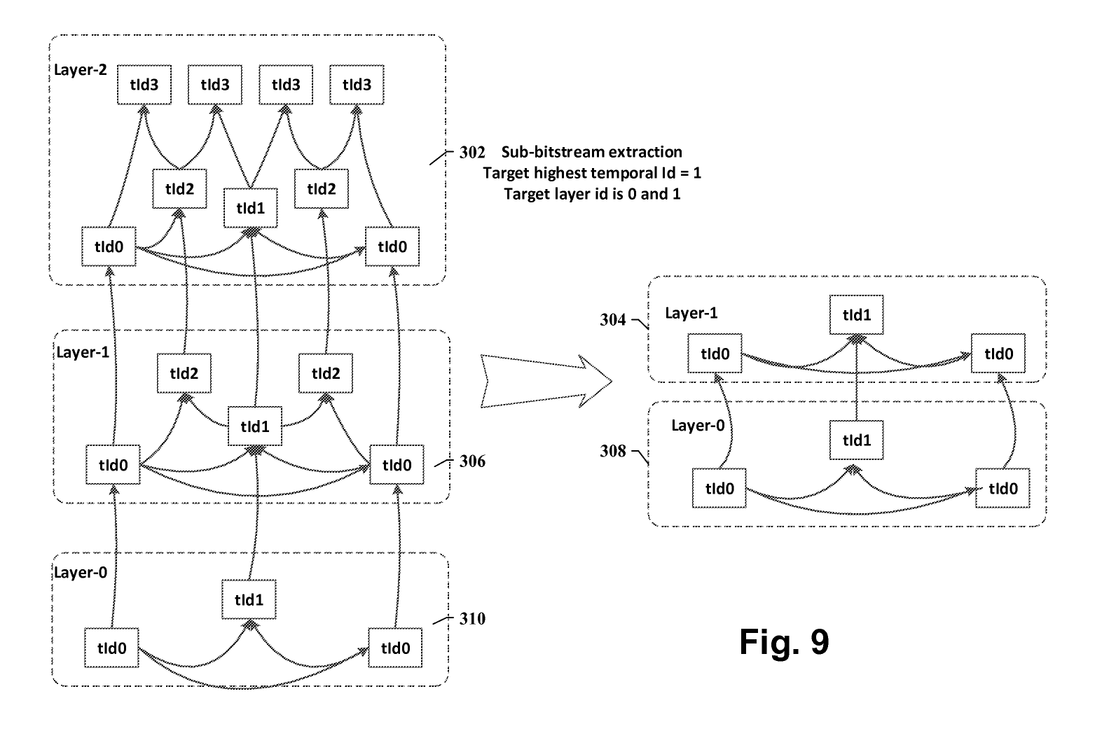

FIG. 9 depicts an example of multiple layer sub-bitstream extraction. The input bitstream has three layers (302, 306, 310), and each layer contains different number of temporal sub-layers. The target layer identifier list includes layer 0 and layer 1, and the highest temporalId value is 1. As a result, the output sub-bitstream after the extraction then contains only 2 temporal sub-layers (tId0 and tId1) of two layers: layer0 (308) and layer1 (304).

One special case of the sub-bitstream extraction process is to extract an independent single layer from the multiple layer bitstream. Such a process is called a re-writing process. The purpose of such re-writing process is to extract an independent non-base layer into a HEVC v1 compliant bitstream by modifying parameter set syntax.

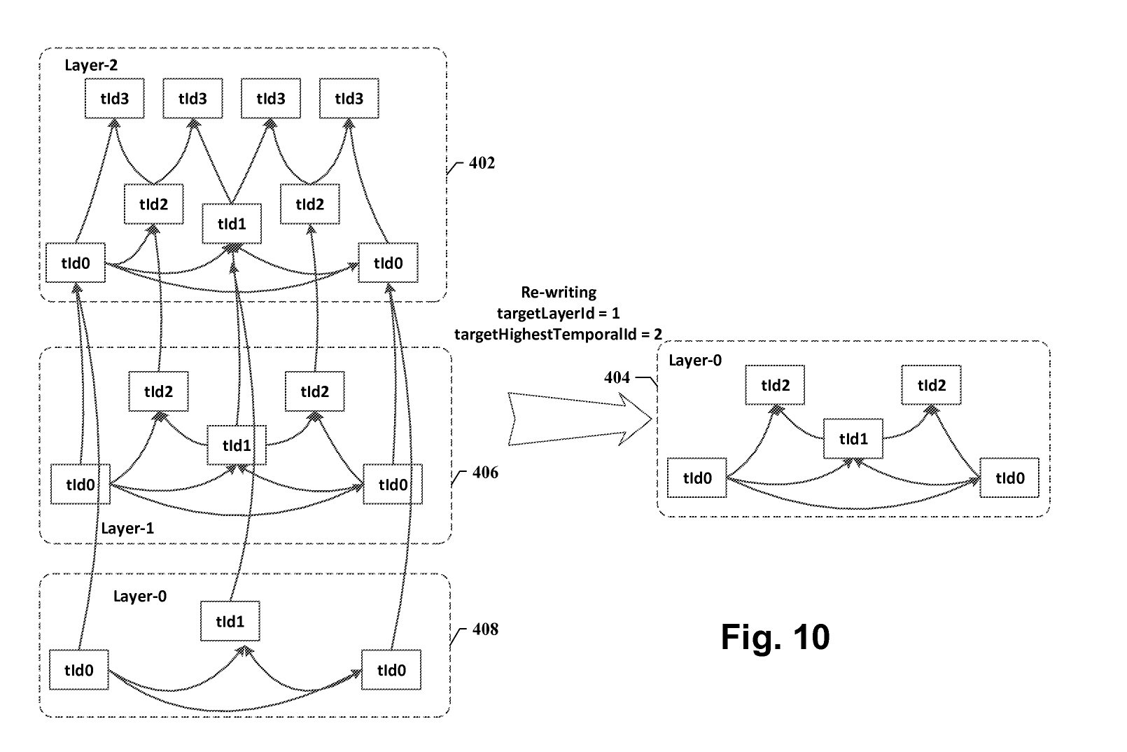

FIG. 10 is an example of a re-writing process; there are two independent layers, layer-0 (408) and layer-1 (406). In contrast, layer-2 (402) depends on both layer-0 and layer-1. The non-base independent layer, layer-1, is extracted from the bitstream to form a single layer bitstream with layer id equal to 0. The output extracted bitstream, whose parameter set syntax elements may be modified or reformed, shall be decodable by a HEVC v1 (single layer) decoder.

The multiple layer sub-bitstream extraction process is more complicated than the single layer given the layer-dependent signaling designed in the parameter sets such as the video parameter set (VPS), sequence parameter set (SPS), and picture parameter set (PPS). For instance, the majority of syntax elements are structured based on the consecutive layer structure in VPS. The extraction process may change the layer structure, which would impact the presence of the related parameter set syntax in the VPS, SPS and/or PPS. Some of the syntax elements are also conditioned by the layer id of the parameter sets. Thus, the extraction process would impact the presence of these syntax elements as well.

One solution is to require a bitstream extractor, for example a middle box such as network element 1490 (described below), to analyze all layer-dependent syntax in the parameter sets and generate new parameter sets based on the particular extracted bitstream. This would not only increase the workload of extractor, but also mandate the extractor to have the capability and knowledge to parse all parameter set syntax and re-generate the parameter sets. In addition, the re-writing process may have to remove unused SPS and PPS with nuh_layer_id equal to 0 and re-format the SPS/PPS that the extracted layer is referring to. However, all these issues are either not covered or not adequately addressed in the SHVC working draft v4.

Described herein are improvements to the sub-bitstream extraction and the re-writing process. Some constraints and extra high level syntax elements are provided in order to simplify the extraction and re-writing process.

In one embodiment, a method utilizes layer set constraints for the sub-bitstream extraction processes. The layer set is a set of layers represented within a bitstream created from another bitstream by operation of the sub-bitstream extraction process on the other bitstream. HEVC specifies the number of layer sets in the VPS and each layer set may contain one or more layers. A layer set consists of all operation points. The operation point is defined as “A bitstream created from another bitstream by operation of the sub-bitstream extraction process with the another bitstream, a target highest TemporalId, and a target layer identifier list as inputs”.

A layer set is a set of actual scalability layers, and a layer set indicates which layers can be extracted from a current bitstream such that the extracted bitstream can be independently decoded by a scalable video decoder. The TemporalId value of a layer set is equal to 6 which includes all temporal sub-layers of each individual layer. Within a single layer set, there could be multiple operation points.

Within a single layer set, an operation point can further identify the temporal scalability subsets as well as combinations of sub-layers. When the target highest TemporalId of an operation point is equal to the greatest TemporalId of the layer set, the operation point is identical to the layer set. Therefore, an operation point could be a layer set, or one particular subset of a layer set.

A layer set could include all existing layers, or a number of dependent layers, or a mix of independent layers and dependent layers. An independent layer is the layer without any direct reference layers. A dependent layer is the layer with at least one direct reference layer. The number of a layer set specifies the possible number of sub-bitstreams to be extracted. The extracted sub-bitstream could be further extracted into another bitstream as long as the another bitstream is specified by the layer set.

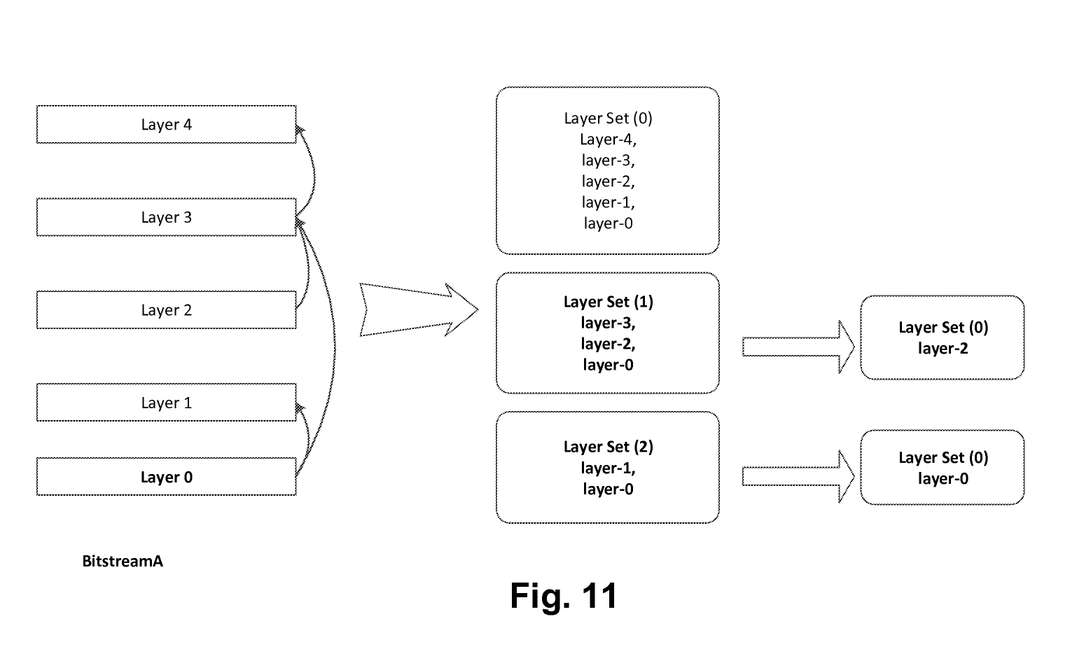

FIG. 11 is an example of layer sets of the bitstream (BitstreamA) for multiple hop sub-bitstream extraction. There are 5 layers and layer-0 and layer-2 are independent layers. Three layer sets can be signaled to output layer-4, layer 3 or layer-1. The layer set 1 can be further extracted to output layer-2, and layer set 2 can also be further extracted to output layer-0.

One specific case of sub-bitstream extraction process is re-writing process, which extracts an independent non-base layer from the bitstream. The independent non-base layer can be derived from the parameter set syntax if it is not signaled in the layer set. To simplify the derivation process of the middle box, in one embodiment, an encoder generates signals in the SEI or VPS VUI section regarding all independent non-base layers.

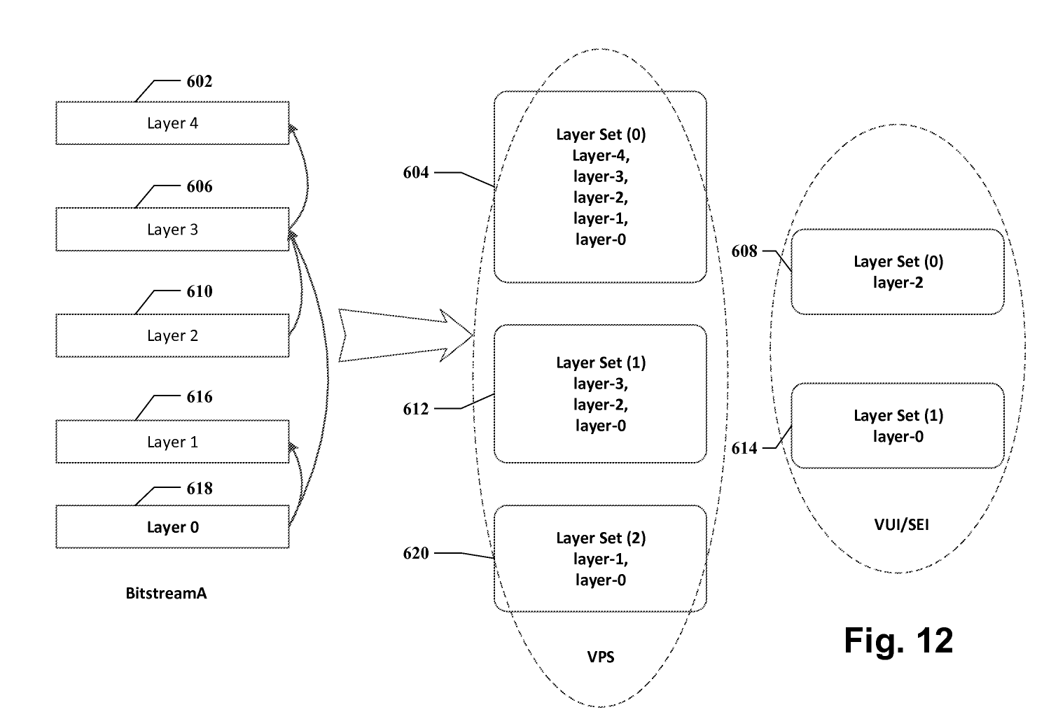

FIG. 12 is an example of the layer set constraint to signal independent non-base layer. In this embodiment, a middle box such as network element 1490 extracts from the VUI or SEI as provided by the encoder, rather than having to regenerate the parameters. In a further alternative embodiment, the encoder signals it in the VPS layer set. Thus middle box 1490 is also relieved of having to do further analysis to determine layer dependencies.

Table 2 is the syntax table of an embodiment of an independent non-base layer SEI message.

TABLE 2
sei_layer_set( ) {

| | |
|---|---|
| sei_num_independent_nonbase_layer_minus1 | ue(v) |
| for( i = 0; i <= | |
| sei_num_independent_non_base_layer_minus1; i++ ) | |

| | |
|---|---|
| sei_indepedent_layer_id[ i ] | u(6) |

}

}

In Table 1, sei_num_independent_nonbase_layer_minus1 plus 1 specifies the number of independent non-base layers, and sei_independent_layer_id[i] specifies the nuh_layer_id value of an independent non-base layer. In order to become a conforming bitstream, a proposed HEVC draft requires that the output bitstream of sub-bitstream extraction shall contain the coded slice segment NAL units with nuh_layer_id equal to 0 and TemporalId equal to 0. However, this may be a problem because a layer set may be defined which does not include the base layer (with nuh_layer_id equal to 0).

Therefore, in some embodiments, this problem is alleviated by using the following constraint on the re-writing process: The nuh_layer_id value of the coded slice segment NAL units of one independent layer of a particular output layer set, layerSetIdx, shall be set equal to 0 in the output sub-bitstream after the sub-bitstream extraction process.

Further embodiments are directed to VPS generation for sub-bitstream extraction processes. VPS and its extension are mainly designed for the session negotiation and capability exchange of video conferencing and streaming applications. Most layer-related syntax elements are structured based on the consecutive layer index given the maximum number of layers (vps_max_layers_minus1). For example, the direct dependency flag, direct_dependency_flag[i][j], indicates the dependency between i-th layer and j-th layer, where j is less than i. After the sub-bitstream extraction process, some layers may be removed and the original consecutive layer structure would be broken. The syntax elements tied to the original layer structure, such as direct_dependency_flag[i][j], would not be applicable to the new sub-bitstream anymore.

One way to solve such issue is to generate a completely new VPS to replace the existing VPS as part of the sub-bitstream extraction process. The bitstream extractor (e.g. middle box) needs to parse the parameter set syntax structure, extract or derive the parameter set syntax for the extracted layers and remove the syntax of the layers being removed, re-structure the remaining parameter sets syntax based on the extracted layer structure, and re-format the VPS and its extensions. Such an approach is consistent with the current specification, but it adds more workload on the middle box which may not be desirable.

In some embodiments, the VPS signaling during the sub-bitstream extraction process is simplified. In particular, in one embodiment, the VPS syntax design for sub-bitstream extraction processes may be improved.

In one embodiment, the middle box conducts the sub-bitstream extraction process without knowledge of the parameter sets syntax. In this embodiment, the bitstream is formulated such that each layer set shall have a corresponding VPS present in the bitstream. The VPS identifier (vps_video_parameter_set_id) may be mandated to be set equal to the index of the layer set by default, or a layer set index is signaled in VPS to identify which layer set the VPS is referring to. However, current VPS id signal length is 4 bits, while the maximum value of vps_num_layer_sets_minus1 is 1023, which allows up to 1024 layer sets. In order to accommodate maximum number of layer sets, expansion of the VPS id and the corresponding reference signaling in SPS can be implemented.

VPS identifier extension signaling, e.g. vps_video_parameter_{—} set_id_extension, can be added in the VPS structure and be valid when vps_video_parameter_set_id is equal to a particular value, e.g. 15. The extension of sps_video_parameter_set_id used to refer VPS shall also be expanded by new element syntax, e.g. sps_video_parameter_set_id_extension, in SPS when the nuh_layer_id of SPS is greater than 0 and the sps_video_parameter_set_id is equal to a particular value, e.g. 15. The semantic of proposed syntax elements are as follows:

vps_video_parameter_set_id_extension identifies the VPS for reference by other syntax elements when vps_video_parameter_set_id is equal to 15. The value of vps_video_parameter_set_id_extension shall be in the range of 0 to 1024.

sps_video_parameter_set_id_extension specifies the value of the vps_video_parameter_set_id_extension of the active VPS. The value of sps_vps_video_parameter_set_id_extension shall be in the range of 0 to 1024.

An alternative way to match the VPS to each layer set without expanding the VPS id is to restrict the number of layer sets allowed in the SHVC main profile.

Another method is to associate parameter set syntax to various operation points or with specific layer set. The VPS syntax elements associated to the layer set is shown in Table 3 with prefix “ls”.

Each syntax element shares the same semantic with its corresponding syntax element in VPS, but the value of each syntax element is specified based on each individual layer set with particular layer structure.

The layer set info shown in Table 3 can be signaled in VPS, VPS extension, VPS VUI or SEI message so that the middle box is aware of the parameter values of each layer set, and is able to reform the VPS, either by copying the value of particular layer set parameters to the corresponding VPS parameters, or directly referring to the corresponding layer_set_info( ) of a particular layer set which the sub-bitstream extraction conducts on by the index of layer set.

TABLE 3
Layer Set Info

De-
scrip-
tor

layer_set_info( ) {

for( s = 0; s <= vps_num_layer_sets_minus1; s++ ) {

| | |
|---|---|
| ls_max_layers_minus1[s] | u(6) |
| ls_max_sub_layers_minus1[s] | u(3) |
| ls_temporal_id_nesting_flag[s] | u(1) |
| ls_max_layer_id[s] | u(6) |
| ls_num_layer_sets_minus1[s] | ue(v) |
| for( i = 1; i <= ls_num_layer_sets_minus1[s]; i++ ) | |

for( j = 0; j <= ls_max_layer_id[s]; j++ )

| | |
|---|---|
| ls_layer_id_included_flag[s] [ i ][ j ] | u(1) |

| | |
|---|---|
| ls_avc_base_layer_flag[s] | u(1) |
| for( i = 1; i <= ls_num_layer_sets_minus1[s]; i++ ) | |

for( j = 0; j < i; j++ )

| | |
|---|---|
| ls_direct_dependency_flag[s] [ i ][ j ] | u(1) |

| | |
|---|---|
| ls_sub_layers_max_minus1_present_flag[s] | u(1) |
| if( ls_sub_layers_max_minus1_present_flag[s] ) | |

for( i = 0; i <= ls_num_layer_sets_minus1[s];
i++ ) {

| | |
|---|---|
| sub_layers_ls_max_minus1[s] [ i ] | u(3) |
| ls_profile_level_tier_idx[s] [ i ] | u(v) |

| | |
|---|---|
| } | |
| ls_max_tid_ref_present_flag[s] | u(1) |
| if( ls_max_tid_ref_present_flag[s] ) | |

for( i = 0; i < ls_num_layer_sets_minus1[s]; i++
)

for( j = i + 1; j <=
ls_num_layer_sets_minus1[s]; j++ )

if( ls_direct_dependency_flag[s] [ j ][ i ]
)

| | |
|---|---|
| ls_max_tid_il_ref_pics_plus1[s] [ | u(3) |
| i ][ j ] | |

| | |
|---|---|
| ls_all_ref_layers_active_flag[s] | u(1) |
| if( ls_max_layers_minus1[s] > 0 ) | |

| | |
|---|---|
| ls_alt_output_layer_flag[s] | u(1) |

if( rep_format_idx_present_flag )

for( i = 1; i <= ls_num_layer_sets_minus1[s];
i++ )

if(num_rep_formats_minus1[s] > 0 )

| | |
|---|---|
| ls_rep_format_idx[s] [ i ] | u(8) |

| | |
|---|---|
| ls_max_one_active_ref_layer_flag[s] | u(1) |
| ls_cross_layer_phase_alignment_flag[s] | u(1) |
| if( !default_direct_dependency_flag ) { | |

for( i = 1; i <= ls_num_layer_sets_minus1[s]; i++
)

for( j = 0; j < i; j++ )

if( ls_direct_dependency_flag[s] [ i ][
j ] )

| | |
|---|---|
| ls_direct_dependency_type[s] [ i ][ | u(v) |
| j ] | |

}

}

}

In still further embodiments, an AVC indication layer may be used. The syntax element, avc_base_layer_flag, is signaled in the VPS extension to specify if the base layer conforms to (“1”) H.264 or (“0”) HEVC. However, since the current specification allows multiple independent non-base layers available in the bitstream, an independent non-base layer conforms to H.264 could be available in the bitstream. Therefore, the avc_base_layer_flag is not sufficient to indicate the scenarios. Here, an AVC layer indicator flag is proposed to be signaled for each independent layer as shown in Table 4.

TABLE 4
VPS Extension Syntax

De-
scrip-
tor

vps_extension( ) {

| | |
|---|---|
| ... | u(1) |
| for ( i = 0; i <= MaxLayersMinus1; i++ ) | |

if (NumDirectRefLayers[layer_id_in_nuh[i]] == 0)

| | |
|---|---|
| avc_layer_flag[i] | u(1) |

...

}

An avc_layer_flag equal to 1 specifies that the layer with nuh_layer_id equal to layer_id_in_nuh[i] conforms to Rec. ITU-T H.265 | ISO/IEC 14496-10. An avc_layer_flag equal to 0 specifies that the base layer conforms to the HEVC Specification. When avc_layer_flag is not present, it is inferred to be 0.

When avc_layer_flag[i] is equal to 1, in the Rec. ITU-T H.264 | ISO/IEC 14496-10 conforming layer, after applying the Rec. ITU-T H.264 | ISO/IEC 14496-10 decoding process for reference picture lists construction, the output reference picture lists refPicList0 and refPicList1 (when applicable) does not contain any pictures for which the TemporalId is greater than TemporalId of the coded picture. All sub-bitstreams of the Rec. ITU-T H.264 | ISO/IEC 14496-10 conforming layer, that can be derived using the sub-bitstream extraction process as specified in Rec. ITUT H.264 | ISO/IEC 14496-10 subclause G.8.8.1 with any value for temporal_id as the input shall result in a set of CVSs, with each CVS conforming to one or more of the profiles specified in Rec. ITUT H.264 | ISO/IEC 14496-10 Annexes A, G and H.

When avc_layer_flag[i] is equal to 1, it is a requirement of bitstream conformance that the value of sps_scaling_list_ref layer_id shall not be equal to layer_id_in_nuh[i].

When avc_layer_flag[i] is equal to 1, it is a requirement of bitstream conformance that pps_scaling_list_ref layer_id shall not be equal to layer_id_in_nuh[i].

In another embodiment, the following method is used: only the base layer is coded in AVC/H.264 format and none of the enhancement layers are coded in AVC/H.264 format for scalable extension of HEVC. In these embodiments, the AVC layer indication signaling may not be needed.

SPS and PPS generation may be used in a re-writing process. A sequence parameter set is specified to be activated for a particular layer, and PPS is specified to be activated for a number of pictures. The same SPS can be shared by multiple layers, and the same PPS can be shared by a number of pictures across the multiple layers. The value of the majority syntax elements specified in SPS and PPS can be inherited after the sub-bitstream extraction process.

A special case of the sub-bitstream extraction process is the re-writing process applied to an independent non-base layer with nuh_layer_id greater than 0. The re-writing process is to extract independent layer from the multiple layer bitstream into a HEVC v1 conforming bitstream by rewriting the high level syntax if necessary, for example, setting nuh_layer_id to 0.

A number of syntax elements are signaled differently for SPS/PPS depending on the value of nuh_layer_id, such as sps_max_sub_layers_minus1, sps_temporal_id_nesting_flag, profile_tier_level( ), and rep_format( ). After the re-writing process, the layer id of the active SPS and PPS for the extracted layer shall be changed to 0 because of the SPS and PPS constraint specified in the standard. In that case, the middle box may have to reform the SPS or PPS activated for the independent non-base layer.

In some embodiments, constraints are imposed on SPS and PPS signaling. One way to facilitate the re-writing process is to mandate the independent layer to refer the SPS and PPS whose nuh_layer_id is equal to 0, so that the syntax elements like sps_max_sub_layers_minus1 and sps_temporal_id_nesting_flag and profile_tier_level( ) are kept intact after the re-writing process.

In addition, in further embodiments the value of

chroma_format_vps_idc,

separate_colour_plane_vps_flag,

pic_width_vps_in_luma_samples,

pic_height_vps_in_luma_samples,

bit_depth_vps_luma_minus8, and

bit_depth_vps_chroma_minus8

is signaled in the corresponding rep_format( ) syntax structure in the active VPS for the independent non-base layer and shall be equal to

chroma_format_vps_idc,

separate_colour_plane_vps_flag,

pic_width_vps_in_luma_samples,

pic_height_vps_in_luma_samples,

bit_depth_vps_luma_minus8, and

bit_depth_vps_chroma_minus8,

signaled in the active SPS with nuh_layer_id equal to 0 referred by the independent non-base layer.

After the re-writing process, the same SPS and PPS can be directly referred by the base layer.

Another method to reform the SPS for the re-writing process is to restructure these syntax elements that are signaled differently for SPS based on the value of nuh_layer_id and to rewrite the value of those syntax elements. The value of syntax elements such as sps_max_sub_layers_minus1, sps_temporal_id_nesting_flag, profile_tier_level( ) can be copied from VPS during the re-writing process.

As for the rep_format( ), the value of each element of the corresponding rep_form( ), such as chroma_format_idc, pic_width_in_luma_samples, pic_height_in_luma_samples, bit_depth_luma_minus8 and bit_depth_chroma_minus8, signaled in the active VPS for the independent non-base layer shall be copied to the corresponding chroma_format_idc, pic_width_in_luma_samples, pic_height_in_luma_samples, bit_depth_luma_minus8 and bit_depth_chroma_minus8 signaled in the SPS.

The nuh_layer_id of the active SPS and PPS for the independent non-base layer shall be changed to 0 during the rewriting process.

Since the VPS and its extension could be discarded during the rewriting process, a duplication copy of sps_max_sub_layers_minus1, sps_temporal_id_nesting_flag, profile_tier_level( ), and rep_format( ) needed for SPS/PPS re-writing process may be signaled in SPS VUI or SEI message to facilitate the SPS/PPS rewriting.

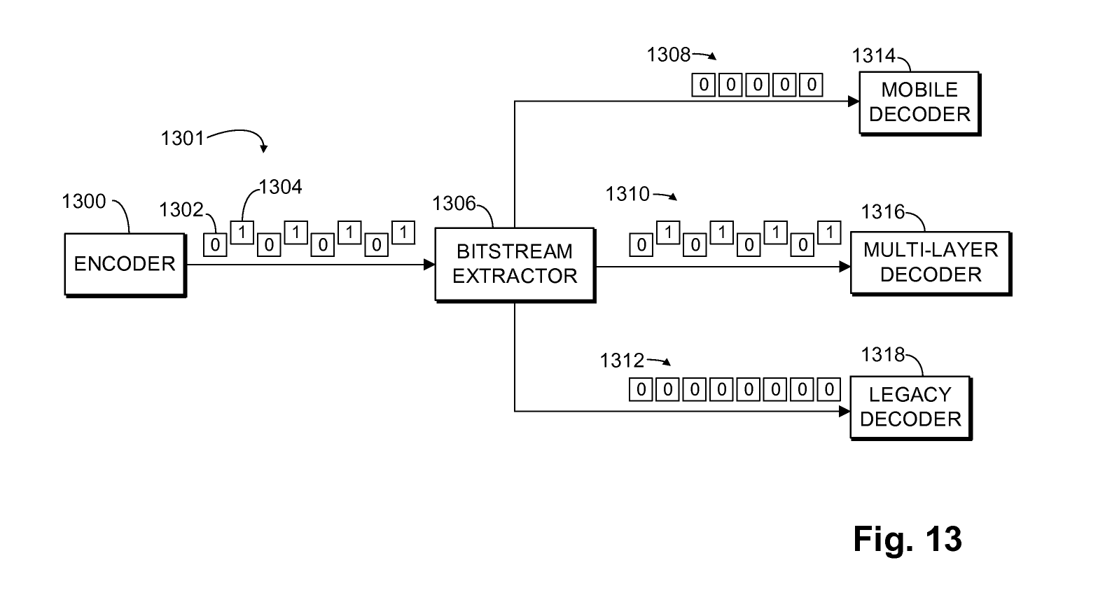

FIG. 13 is a diagram illustrating an example of a communication system. The communication system may comprise an encoder 1300 and decoders 1314, 1316, 1318 in communication over a communication network. The encoder 1300 is a multilayer encoder and may be similar to the multi-layer (e.g., two-layer) scalable coding system with picture-level ILP support of FIG. 3. The encoder 1300 generates a multi-layer scalable bitstream 1301. The scalable bitstream 1301 includes at least a base layer and a non-base layer. The bitstream 1301 is depicted schematically as a series of layer-0 NAL units (such as unit 1302) and a series of layer-1 NAL units 1304.

The encoder 1300 and the decoders 1314, 1316, 1318 may be incorporated into a wide variety of wired communication devices and/or wireless transmit/receive units (WTRUs), such as, but not limited to, digital televisions, wireless broadcast systems, a network element/terminal, servers, such as content or web servers (e.g., such as a Hypertext Transfer Protocol (HTTP) server), personal digital assistants (PDAs), laptop or desktop computers, tablet computers, digital cameras, digital recording devices, video gaming devices, video game consoles, cellular or satellite radio telephones, digital media players, and/or the like.

The communications network between the encoder 1300 and the decoders 1314, 1316, 1318 may be any suitable type of communication network. For example, the communications network may be a multiple access system that provides content, such as voice, data, video, messaging, broadcast, etc., to multiple wireless users. The communications network may enable multiple wireless users to access such content through the sharing of system resources, including wireless bandwidth. For example, the communications network may employ one or more channel access methods, such as code division multiple access (CDMA), time division multiple access (TDMA), frequency division multiple access (FDMA), orthogonal FDMA (OFDMA), single-carrier FDMA (SC-FDMA), and/or the like. The communication network may include multiple connected communication networks. The communication network may include the Internet and/or one or more private commercial networks such as cellular networks, Wi-Fi hotspots, Internet Service Provider (ISP) networks, and/or the like.

A bitstream extractor 1306 may be positioned between the encoder and the decoders in the network. The bitstream extractor 1306 may be implemented using, for example, the components of network entity 1490, described below. The bitstream extractor 1306 is operative to tailor the multi-layer bitstream 1301 for different decoders in different circumstances. For example, decoder 1316 may be capable of decoding multi-layer bitstreams and may be similar to the decoder 400 illustrated in FIG. 4. Thus, the bitstream 1310 sent by the bitstream extractor 1306 to the multi-layer decoder 1316 may be identical to the original multi-layer bitstream 1301. A different decoder 1314 may be implemented on a WTRU or other mobile device for which bandwidth is limited. Thus, the bitstream extractor 1306 may operate to remove NAL units from one or more non-base layers (such as unit 1304), resulting in a bitstream 1308 with a lower bitrate than the original multi-layer stream 1301.

The bitstream extractor 1306 can also provide services to a legacy decoder 1318, which may have a high bandwidth network connection but is not capable of decoding multi-layer video. In a rewriting process as described above, the bitstream extractor 1306 rewrites the original bitstream 1301 into a new bitstream 1312 that includes only a single layer.

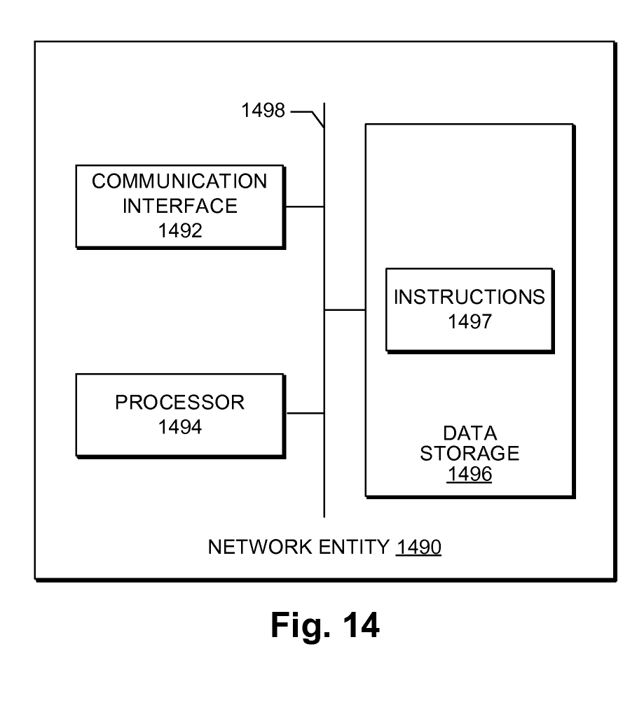

FIG. 14 depicts an exemplary network entity 1490 that may be used within a communication network, for example as a middle box or bitstream extractor. As depicted in FIG. 14, network entity 1490 includes a communication interface 1492, a processor 1494, and non-transitory data storage medium 1496, all of which are communicatively linked by a bus, network, or other communication path 1498.

Communication interface 1492 may include one or more wired communication interfaces and/or one or more wireless-communication interfaces. With respect to wired communication, communication interface 1492 may include one or more interfaces such as Ethernet interfaces, as an example. With respect to wireless communication, communication interface 1492 may include components such as one or more antennae, one or more transceivers/chipsets designed and configured for one or more types of wireless (e.g., LTE) communication, and/or any other components deemed suitable by those of skill in the relevant art. And further with respect to wireless communication, communication interface 1492 may be equipped at a scale and with a configuration appropriate for acting on the network side—as opposed to the client side—of wireless communications (e.g., LTE communications, Wi-Fi communications, and the like). Thus, communication interface 1492 may include the appropriate equipment and circuitry (perhaps including multiple transceivers) for serving multiple mobile stations, UEs, or other access terminals in a coverage area.

Processor 1494 may include one or more processors of any type deemed suitable by those of skill in the relevant art, some examples including a general-purpose microprocessor and a dedicated DSP.

Data storage 1496 may take the form of any non-transitory computer-readable medium or combination of such media, some examples including flash memory, read-only memory (ROM), and random-access memory (RAM) to name but a few, as any one or more types of non-transitory data storage deemed suitable by those of skill in the relevant art could be used. As depicted in FIG. 14, data storage 1496 contains program instructions 1497 executable by processor 1494 for carrying out various combinations of the various network-entity functions described herein.

In some embodiments, the middle box, bitstream extractor, and other functions described herein are carried out by a network entity having a structure similar to that of network entity 1490 of FIG. 14. In some embodiments, one or more of such functions are carried out by a set of multiple network entities in combination, where each network entity has a structure similar to that of network entity 1490 of FIG. 14. In various different embodiments, network entity 190 is—or at least includes—one or more of (one or more entities in) a radio access network (RAN), core network, base station, Node-B, radio network controller (RNC), media gateway (MGW), mobile switching center (MSC) 146, serving GPRS support node (SGSN), gateway GPRS support node (GGSN), eNode-B, mobile management entity (MME), serving gateway, packet data network (PDN) gateway, access service network (ASN) gateway, mobile IP home agent (MIP-HA), or authentication, authorization and accounting (AAA) server. Other network entities and/or combinations of network entities could be used in various embodiments for carrying out the network-entity functions described herein, as the foregoing list is provided by way of example and not by way of limitation.

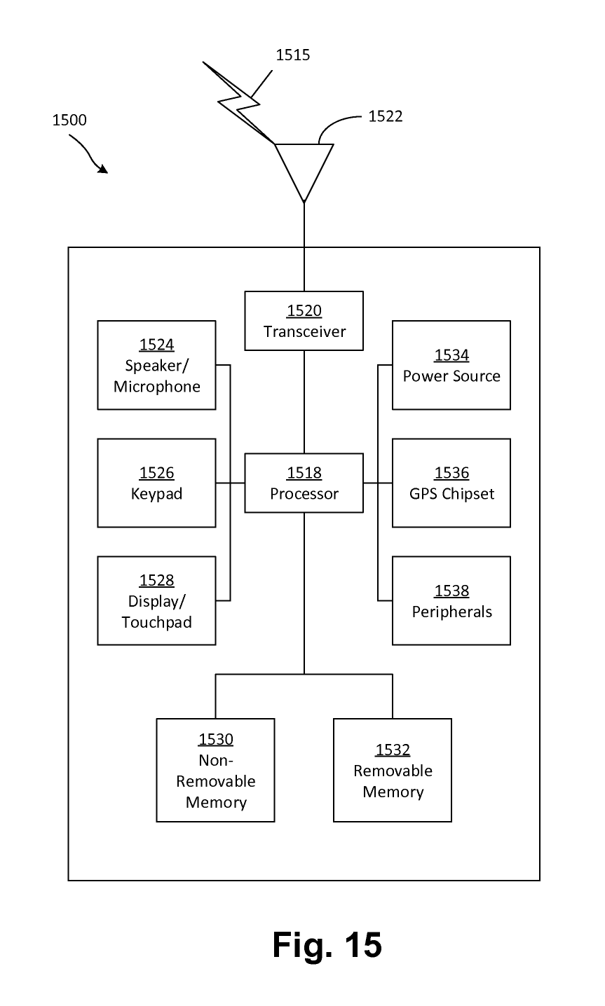

FIG. 15 is a system diagram of an exemplary WTRU in which a video encoder, decoder, or middle box such as a bitstream extractor can be implemented. As shown the example, WTRU 1500 may include a processor 1518, a transceiver 1520, a transmit/receive element 1522, a speaker/microphone 1524, a keypad or keyboard 1526, a display/touchpad 1528, non-removable memory 1530, removable memory 1532, a power source 1534, a global positioning system (GPS) chipset 1536, and/or other peripherals 1538. It will be appreciated that the WTRU 1500 may include any sub-combination of the foregoing elements while remaining consistent with an embodiment. Further, a terminal in which an encoder (e.g., encoder 100) and/or a decoder (e.g., decoder 200) is incorporated may include some or all of the elements depicted in and described herein with reference to the WTRU 1500 of FIG. 15.

The processor 1518 may be a general purpose processor, a special purpose processor, a conventional processor, a digital signal processor (DSP), a graphics processing unit (GPU), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 1518 may perform signal coding, data processing, power control, input/output processing, and/or any other functionality that enables the WTRU 1500 to operate in a wired and/or wireless environment. The processor 1518 may be coupled to the transceiver 1520, which may be coupled to the transmit/receive element 1522. While FIG. 15 depicts the processor 1518 and the transceiver 1520 as separate components, it will be appreciated that the processor 1518 and the transceiver 1520 may be integrated together in an electronic package and/or chip.

The transmit/receive element 1522 may be configured to transmit signals to, and/or receive signals from, another terminal over an air interface 1515. For example, in one or more embodiments, the transmit/receive element 1522 may be an antenna configured to transmit and/or receive RF signals. In one or more embodiments, the transmit/receive element 1522 may be an emitter/detector configured to transmit and/or receive IR, UV, or visible light signals, for example. In one or more embodiments, the transmit/receive element 1522 may be configured to transmit and/or receive both RF and light signals. It will be appreciated that the transmit/receive element 1522 may be configured to transmit and/or receive any combination of wireless signals.

In addition, although the transmit/receive element 1522 is depicted in FIG. 15 as a single element, the WTRU 1500 may include any number of transmit/receive elements 1522. More specifically, the WTRU 1500 may employ MIMO technology. Thus, in one embodiment, the WTRU 1500 may include two or more transmit/receive elements 1522 (e.g., multiple antennas) for transmitting and receiving wireless signals over the air interface 1515.

The transceiver 1520 may be configured to modulate the signals that are to be transmitted by the transmit/receive element 1522 and/or to demodulate the signals that are received by the transmit/receive element 1522. As noted above, the WTRU 1500 may have multi-mode capabilities. Thus, the transceiver 1520 may include multiple transceivers for enabling the WTRU 1500 to communicate via multiple RATs, such as UTRA and IEEE 802.11, for example.

The processor 1518 of the WTRU 1500 may be coupled to, and may receive user input data from, the speaker/microphone 1524, the keypad 1526, and/or the display/touchpad 1528 (e.g., a liquid crystal display (LCD) display unit or organic light-emitting diode (OLED) display unit). The processor 1518 may also output user data to the speaker/microphone 1524, the keypad 1526, and/or the display/touchpad 1528. In addition, the processor 1518 may access information from, and store data in, any type of suitable memory, such as the non-removable memory 1530 and/or the removable memory 1532. The non-removable memory 1530 may include random-access memory (RAM), read-only memory (ROM), a hard disk, or any other type of memory storage device. The removable memory 1532 may include a subscriber identity module (SIM) card, a memory stick, a secure digital (SD) memory card, and the like. In one or more embodiments, the processor 1518 may access information from, and store data in, memory that is not physically located on the WTRU 1500, such as on a server or a home computer (not shown).

The processor 1518 may receive power from the power source 1534, and may be configured to distribute and/or control the power to the other components in the WTRU 1500. The power source 1534 may be any suitable device for powering the WTRU 1500. For example, the power source 1534 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 1518 may be coupled to the GPS chipset 1536, which may be configured to provide location information (e.g., longitude and latitude) regarding the current location of the WTRU 1500. In addition to, or in lieu of, the information from the GPS chipset 1536, the WTRU 1500 may receive location information over the air interface 1515 from a terminal (e.g., a base station) and/or determine its location based on the timing of the signals being received from two or more nearby base stations. It will be appreciated that the WTRU 1500 may acquire location information by way of any suitable location-determination method while remaining consistent with an embodiment.

The processor 1518 may further be coupled to other peripherals 1538, which may include one or more software and/or hardware modules that provide additional features, functionality and/or wired or wireless connectivity. For example, the peripherals 1538 may include an accelerometer, orientation sensors, motion sensors, a proximity sensor, an e-compass, a satellite transceiver, a digital camera and/or video recorder (e.g., for photographs and/or video), a universal serial bus (USB) port, a vibration device, a television transceiver, a hands free headset, a Bluetooth® module, a frequency modulated (FM) radio unit, and software modules such as a digital music player, a media player, a video game player module, an Internet browser, and the like.

By way of example, the WTRU 1500 may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a tablet computer, a personal computer, a wireless sensor, consumer electronics, or any other terminal capable of receiving and processing compressed video communications.

The WTRU 1500 and/or a communication network (e.g., communication network 804) may implement a radio technology such as Universal Mobile Telecommunications System (UMTS) Terrestrial Radio Access (UTRA), which may establish the air interface 1515 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA). The WTRU 1500 and/or a communication network (e.g., communication network 804) may implement a radio technology such as Evolved UMTS Terrestrial Radio Access (E-UTRA), which may establish the air interface 1515 using Long Term Evolution (LTE) and/or LTE-Advanced (LTE-A).

The WTRU 1500 and/or a communication network (e.g., communication network 804) may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like. The WTRU 1500 and/or a communication network (e.g., communication network 804) may implement a radio technology such as IEEE 802.11, IEEE 802.15, or the like.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

We claim:

1. A method comprising:
encoding a video as a multi-layer scalable bitstream including at least a base layer and a first non-base layer, each of the layers including a plurality of image slice segments, and the base layer including at least one picture parameter set (PPS);
wherein the base layer and the first non-base layer each include a plurality of image slice segments, and wherein each of the image slice segments in the first non-base layer refers to a respective one of the picture parameter sets in the base layer.

2. The method of claim 1, wherein each of the image slice segments in the first non-base layer refers to a picture parameter set having a layer identifier nuh_layer_id of zero.

3. The method of claim 1, wherein the base layer comprises a plurality of network abstraction layer (NAL) units having a layer identifier nuh_layer_id of zero, and wherein the first non-base layer comprises a plurality of network abstraction layer (NAL) units having a layer identifier nuh_layer_id greater than zero.

4. The method of claim 1, wherein the multi-layer scalable bitstream further includes a second non-base layer.

5. The method of claim 1, wherein the non-base layer is an independent layer.

6. The method of claim 1, wherein each layer is associated with a layer identifier, and the multi-layer scalable bitstream comprises a plurality of network abstraction layer (NAL) units, each NAL unit including a layer identifier.

7. The method of claim 1, wherein the base layer includes at least one sequence parameter set (SPS), and wherein each of the image slice segments in the first non-base layer refers to a respective one of the sequence parameter sets in the base layer.

8. The method of claim 7, wherein each of the image slice segments in the first non-base layer refers to a sequence parameter set having a layer identifier nuh_layer_id of zero.

9. The method of claim 1, further comprising rewriting the multi-layer scalable bitstream as a single-layer bitstream.

10. The method of claim 9, wherein multi-layer scalable bitstream further comprises a sps_max_sub_layers_minus1 parameter, and wherein the sps_max_sub_layers_minus1 parameter is not changed during the rewriting process.

11. The method of claim 9, wherein multi-layer scalable bitstream further comprises a profile_tier_level( ) parameter, and wherein the profile_tier_level( ) parameter is not changed during the rewriting process.

12. The method of claim 1, wherein:
the multi-layer scalable bitstream includes at least one sequence parameter set (SPS) having a first plurality of video parameters and at least one video parameter set (VPS) having a second plurality of video parameters;
each of the image slice segments in the first non-base layer refers to a respective one of the sequence parameter sets in the base layer and to a respective one of the video parameter sets; and
a first subset of the first plurality of video parameters and a second subset of the second plurality of video parameters are equal.

13. The method of claim 12, wherein the first subset of the first plurality of video parameters and the second subset of second plurality of video parameters include the parameters:
chroma_format_vps_idc,
separate_colour_plane_vps_flag,
pic_width_vps_in_luma_samples,
pic_height_vps_in_luma_samples,
bit_depth_vps_luma_minus8, and
bit_depth_vps_chroma_minus8.

14. The method of claim 12, wherein first subset of the first plurality of video parameters and the second subset of the second plurality of video parameters include the parameters of a rep_format( ) syntax structure.

15. The method of claim 12, further comprising rewriting the multi-layer scalable bitstream as a single-layer bitstream, wherein the rewriting is performed without altering the sequence parameter sets and video parameter sets referred to by the image slice segments in the first non-base layer.

16. A method comprising:
receiving a video encoded as a multi-layer scalable bitstream including at least a base layer and a first non-base layer, each of the layers including a plurality of image slice segments, and the base layer including at least one picture parameter set (PPS);
wherein the base layer and the first non-base layer each include a plurality of image slice segments, and wherein each of the image slice segments in the first non-base layer refers to a respective one of the picture parameter sets in the base layer.
rewriting the video as a single-layer bitstream.

17. The method of claim 16, further comprising sending the single-layer bitstream over a network interface.

18. The method of claim 16, wherein the at least one picture parameter set includes a set of syntax elements, and wherein rewriting the video includes preserving the set of syntax elements.

19. The method of claim 16, wherein the base layer includes at least one sequence parameter set (SPS), and wherein each of the image slice segments in the first non-base layer refers to a respective one of the sequence parameter sets in the base layer.

20. The method of claim 19, wherein the at least one sequence parameter set includes a set of syntax elements, and wherein rewriting the video includes preserving the set of syntax elements.

21. The method of claim 16, wherein the set of syntax elements include the elements:
sps_max_sub_layers_minus1,
sps_temporal_id_nesting_flag, and
profile_tier_level( ).

22. A video encoder including a processor and a non-transitory storage medium, the storage medium storing instructions that, when executed on the processor, are operative:
to encode a video as a multi-layer scalable bitstream including at least a base layer and a first non-base layer, each of the layers including a plurality of image slice segments, and the base layer including at least one picture parameter set (PPS);
wherein the base layer and the first non-base layer each include a plurality of image slice segments, and wherein each of the image slice segments in the first non-base layer refers to a respective one of the picture parameter sets in the base layer.

23. The encoder of claim 22, wherein the base layer includes at least one sequence parameter set (SPS), and wherein each of the image slice segments in the first non-base layer refers to a respective one of the sequence parameter sets in the base layer.

24. The encoder of claim 22, wherein:
the multi-layer scalable bitstream includes at least one sequence parameter set (SPS) having a first plurality of video parameters and at least one video parameter set (VPS) having a second plurality of video parameters;
each of the image slice segments in the first non-base layer refers to a respective one of the sequence parameter sets in the base layer and to a respective one of the video parameter sets; and
a first subset of the first plurality of video parameters and a second subset of the second plurality of video parameters are equal.

25. The encoder of claim 24, wherein the first subset of the first plurality of video parameters and the second subset of the second plurality of video parameters include the parameters of a rep_format( ) syntax structure.
